(19) United States
(12) Patent Application Publication
(10) Pub. No.: US 2024/0095100 A1
(43) Pub. Date: Mar. 21, 2024

(54) APPLICATION PROGRAMMING INTERFACE TRANSLATION

(71) Applicant: Lenovo (Singapore) Pte. Ltd., New Tech Park (SG)

(72) Inventors: Emmanouil Pateromichelakis, Viersen (DE); Ishan Vaishnavi, München (DE)

(21) Appl. No.: 18/262,095

(22) PCT Filed: Jan. 20, 2021
(86) PCT No.: PCT/EP2021/051204

§ 371 Date: Jul. 19, 2023

(51) Int. Cl. G06F 9/54

(52) U.S. Cl. CPC G06F 9/541

(57) ABSTRACT

Apparatuses, methods, and systems are disclosed for application programming interface translation. One method (900) includes (902) receiving a request for invoking a service application programming interface. The method (900) includes translating (904) the service application programming interface to a slice application programming interface. The method (900) includes invoking (906) the translated slice application programming interface. Invoking the translated slice application programming interface may include making a translated slice application programming interface request to a service producer, receiving a translated slice application programming interface response from the service producer, or a combination thereof.

### FIELD

The subject matter disclosed herein relates generally to wireless communications and more particularly relates to application programming interface translation.

### BACKGROUND

The following abbreviations are herewith defined, at least some of which are referred to within the following description: Third Generation Partnership Project (“3GPP”), 5^{th} Generation (“5G”), 5G Core Network (“5GC”), 5G System (“5GS”), 5G QoS Indicator (“5QI”), Authentication, Authorization, and Accounting (“AAA”), Application Client (“AC”), Positive-Acknowledgment (“ACK”), API Exposing Function (“AEF”), Application Function (“AF”), Automated Guided Vehicles (“AGV”), Artificial Intelligence (“AI”), Authentication and Key Agreement (“AKA”), Aggregation Level (“AL”), Access and Mobility Management Function (“AMF”), Angle of Arrival (“AoA”), Angle of Departure (“AoD”), Access Point (“AP”), Application Programmable Interface (“API”), Augmented Reality (“AR”), Access Stratum (“AS”), Application Service Provider (“ASP”), Autonomous Uplink (“AUL”), Authentication Server Function (“AUSF”), Authentication Token (“AUTN”), Background Data (“BD”), Background Data Transfer (“BDT”), Beam Failure Detection (“BFD”), Beam Failure Recovery (“BFR”), Binary Phase Shift Keying (“BPSK”), Base Station (“BS”), Buffer Status Report (“BSR”), Bandwidth (“BW”), Bandwidth Part (“BWP”), Control to Control (“C2C”), Cell RNTI (“C-RNTI”), Carrier Aggregation (“CA”), Channel Access Priority Class (“CAPC”), Common API Framework (“CAPIF”), Channel Busy Ratio (“CBR”), Contention-Based Random Access (“CBRA”), Clear Channel Assessment (“CCA”), Common Control Channel (“CCCH”), Control Channel Element (“CCE”), CAPIF Core Function (“CCF”), Cyclic Delay Diversity (“CDD”), Code Division Multiple Access (“CDMA”), Control Element (“CE”), Contention-Free Random Access (“CFRA”), Configured Grant (“CG”), Closed-Loop (“CL”), Core Network (“CN”), CN User Plane (“CN-U”), Coordinated Multipoint (“CoMP”), Category of Requirements (“CoR”), Channel Occupancy Time (“COT”), Cyclic Prefix (“CP”), Channel Quality Indicator (“CQI”), Cyclical Redundancy Check (“CRC”), Communication Service (“CS”), Channel State Information (“CSI”), Channel State Information-Reference Signal (“CSI-RS”), Common Search Space (“CSS”), Control Resource Set (“CORESET”), Discrete Fourier Transform Spread (“DFTS”), Dual Connectivity (“DC”), Downlink Control Information (“DCI”), Downlink Feedback Information (“DFI”), Dynamic Grant (“DG”), Downlink (“DL”), Demodulation Reference Signal (“DMRS”), Data Network (“DN”), Data Network Name (“DNN”), Data Radio Bearer (“DRB”), Discontinuous Reception (“DRX”), Dedicated Short-Range Communications (“DSRC”), Downlink Pilot Time Slot (“DwPTS”), Enhanced Clear Channel Assessment (“eCCA”), Enhanced Mobile Broadband (“eMBB”), Evolved Node B (“eNB”), Enhanced V2X (“eV2X”), End-to-End (“E2E”), Extensible Authentication Protocol (“EAP”), Edge Application Server (“EAS”), Edge Configuration Server (“ECS”), Edge Enabler Client (“EEC”), Edge Enabler Server (“EES”), Exposure Governance Management Function (“EGMF”), Enhanced ICIC (“eICIC”), Effective Isotropic Radiated Power (“EIRP”), Evolved Packet System (“EPS”), European Telecommunications Standards Institute (“ETSI”), Feature Advertising Service Producer (“FASP”), Frame Based Equipment (“FBE”), Frequency Division Duplex (“FDD”), Frequency Division Multiplexing (“FDM”), Frequency Division Multiple Access (“FDMA”), Frequency Division Orthogonal Cover Code (“FD-OCC”), Factory of the Future or Future Factories (“FF”), Fully Qualified Domain Name (“FQDN”), Frequency Range 1—sub 6 GHz frequency bands and/or 410 MHz to 7125 MHz (“FR1”), Frequency Range 2—24.25 GHz to 52.6 GHz (“FR2”), Universal Geographical Area Description (“GAD”), Guaranteed Bit Rate (“GBR”), Guaranteed Flow Bit Rate (“GFBR”), Group Leader (“GL”), Group Management Server (“GMS”), 5G Node B or Next Generation Node B (“gNB”), Global Navigation Satellite System (“GNSS”), General Packet Radio Services (“GPRS”), Guard Period (“GP”), Global Positioning System (“GPS”), Generic Public Subscription Identifier (“GPSI”), Global System for Mobile Communications (“GSM”), Generic Network Slice Template (“GST”), Globally Unique Temporary UE Identifier (“GUTI”), Home AMF (“hAMF”), Hybrid Automatic Repeat Request (“HARQ”), Home Location Register (“HLR”), Handover (“HO”), Home PLMN (“HPLMN”), Home Subscriber Server (“HSS”), Hash Expected Response (“HXRES”), Inter-cell Interference Coordination (“ICIC”), Identity or Identifier (“ID”), Information Element (“IE”), Industrial Internet of Things (“IIoT”), International Mobile Equipment Identity (“IMEI”), International Mobile Subscriber Identity (“IMSI”), International Mobile Telecommunications (“IMT”), Information Object Class (“IoC”), Internet-of-Things (“IoT”), Internet Protocol (“IP”), Intelligent Transportation Systems (“ITS”), Key Performance Indicator (“KPI”), Layer 1 (“L1”), Layer 2 (“L2”), Layer 3 (“L3”), Licensed Assisted Access (“LAA”), Local Area Data Network (“LADN”), Local Area Network (“LAN”), Load Based Equipment (“LBE”), Listen-Before-Talk (“LBT”), Logical Channel (“LCH”), Logical Channel Group (“LCG”), Logical Channel Prioritization (“LCP”), Log-Likelihood Ratio (“LLR”), Location Management Server (“LMS”), Level of Automation (“LoA”), Line of Sight (“LOS”), Long Term Evolution (“LTE”), LTE Vehicle (“LTE-V”), Multiple Access (“MA”), Medium Access Control (“MAC”), Multimedia Broadcast Multicast Services (“MBMS”), Maximum Bit Rate (“MBR”), Minimum Communication Range (“MCR”), Modulation Coding Scheme (“MCS”), Management Domain (“MD”), Multi-service Digital Distribution System Access System (“MDAS”), Managed Entity or Managed Element (“ME”), Mobile Edge Computing (“MEC”), Management Exposure Function (“MEF”), Master Information Block (“MIB”), Massive IoT (“mIoT”), Multiple Input Multiple Output (“MIMO”), Machine Learning (“ML”), Mobility Management (“MM”), Mobility Management Entity (“MME”), Master Node (“MN”), Management Service (“MnS”), Mobile Network Operator (“MNO”), Mobile Originated (“MO”), Managed Object Instance (“MOI”), Mean Opinion Score (“MOS”), massive MTC (“mMTC”), Multi-point (“MP”), Maximum Power Reduction (“MPR”), Multi-Radio Dual Connectivity (“MR-DC”), Management System (“MS”), Machine Type Communication (“MTC”), Multiple Transmission and Reception Point (“M-TRP”), Multi User Shared Access (“MUSA”), Non Access Stratum (“NAS”), Narrowband (“NB”), Negative-Acknowledgment or Non-Acknowledgment (“NACK”) or (“NAK”), New Data Indicator (“NDI”), Network Entity (“NE”), Network Exposure Function (“NEF”), Network Exposure Function/Service Capability Exposure Function (“NEF/SCEF”), NEtwork Slice Type (“NEST”), Network Function (“NF”), Non-LOS (“NLOS”), Next Generation (“NG”), NG 5G S-TMSI (“NG-5G-S-TMSI”), Neural Networks (“NN”), Non-Orthogonal Multiple Access (“NOMA”), Non Public Network (“NPN”), New Radio (“NR”), NR Unlicensed (“NR-U”), Network Repository Function (“NRF”), Network Slice as a Service (NsaaS), Network Slice Enabler (“NSE”), Network Scheduled Mode (“NS Mode”) (e.g., network scheduled mode of V2X communication resource allocation—Mode-1 in NR V2X and Mode-3 in LTE V2X), Network Slice Instance (“NSI”), Network Slice Selection Assistance Information (“NSSAI”), Network Slice Selection Function (“NSSF”), Network Slice Subnet Instance (“NSSI”), Network Slice Selection Policy (“NSSP”), Network Data Analytics Function (“NWDAF”), Operation, Administration, and Maintenance System or Operation and Maintenance Center (“OAM”), Original Equipment Manufacturer (“OEM”), Orthogonal Frequency Division Multiplexing (“OFDM”), Orthogonal Frequency Division Multiple Access (“OFDMA”), Open-Loop (“OL”), Operator Defined Open and Intelligent Radio Access Networks (“O-RAN”), Other System Information (“OSI”), Over-the-top (“OTT”), Power Angular Spectrum (“PAS”), Physical Broadcast Channel (“PBCH”), Power Control (“PC”), UE to UE interface (“PC5”), Principal Component Analysis (“PCA”), Policy and Charging Control (“PCC”), Primary Cell (“PCell”), Policy and Charging Rules Function (“PCRF”), Policy Control Function (“PCF”), Physical Cell Identity (“PCI”), Physical Downlink Control Channel (“PDCCH”), Packet Data Convergence Protocol (“PDCP”), Packet Data Network Gateway (“PGW”), Physical Downlink Shared Channel (“PDSCH”), Pattern Division Multiple Access (“PDMA”), Packet Data Unit (“PDU”), Physical Hybrid ARQ Indicator Channel (“PHICH”), Power Headroom (“PH”), Power Headroom Report (“PHR”), Physical Layer (“PHY”), Public Land Mobile Network (“PLMN”), Precoding Matrix Index (“PMI”), Physical Network Function (“PNF”), Prose Per Packet Priority (“PPPP”), Prose Per Packet Reliability (“PPPR”), PC5 5QI (“PQIs”), Predictive QoS (“P-QoS”), Physical Random Access Channel (“PRACH”), Physical Resource Block (“PRB”), Proximity Services (“ProSe”), Positioning Reference Signal (“PRS”), Physical Sidelink Control Channel (“PSCCH”), Primary Secondary Cell (“PSCell”), Physical Sidelink Feedback Control Channel (“PSFCH”), Physical Uplink Control Channel (“PUCCH”), Physical Uplink Shared Channel (“PUSCH”), QoS Class Identifier (“QCI”), Quasi Co-Located (“QCL”), QoS Flow Indicator (“QFI”), Quality of Experience (“QoE”), Quality of Service (“QoS”), Quadrature Phase Shift Keying (“QPSK”), Registration Area (“RA”), RA RNTI (“RA-RNTI”), Radio Access Network (“RAN”), Random (“RAND”), Radio Access Technology (“RAT”), Serving RAT (“RAT-1”) (serving with respect to Uu), Other RAT (“RAT-2”) (non-serving with respect to Uu), Random Access Procedure (“RACH”), Random Access Preamble Identifier (“RAPID”), Random Access Response (“RAR”), Resource Block Assignment (“RBA”), Resource Element Group (“REG”), Representational State Transfer (“REST”), Rank Indicator (“RI”), RAN Intelligent Controller (“RIC”), Radio Link Control (“RLC”), RLC Acknowledged Mode (“RLC-AM”), RLC Unacknowledged Mode/Transparent Mode (“RLC-UM/TM”), Radio Link Failure (“RLF”), Radio Link Monitoring (“RLM”), Radio Network Information (“RNI”), RNI Service (“RNIS”), Radio Network Temporary Identifier (“RNTI”), Reference Signal (“RS”), Recursive Model (“RM”), Remaining Minimum System Information (“RMSI”), Radio Resource Control (“RRC”), Radio Resource Management (“RRM”), Resource Spread Multiple Access (“RSMA”), Reference Signal Received Power (“RSRP”), Received Signal Strength Indicator (“RSSI”), Real Time (“RT”), Round Trip Time (“RTT”), Receive (“RX”), Service Capability Exposure Function (“SCEF”), Sparse Code Multiple Access (“SCMA”), Service Provider (“SP”), Scheduling Request (“SR”), Sounding Reference Signal (“SRS”), Single Carrier Frequency Division Multiple Access (“SC-FDMA”), Secondary Cell (“SCell”), Secondary Cell Group (“SCG”), Shared Channel (“SCH”), Sidelink Control Information (“SCI”), Sub-carrier Spacing (“SCS”), Supplemental Downlink (“SDL”), Space Division Multiplexing (“SDM”), Service Data Unit (“SDU”), Security Anchor Function (“SEAF”), Service Enabler Architecture Layer (“SEAL”), Sidelink Feedback Content Information (“SFCI”), Serving Gateway (“SGW”), System Information Block (“SIB”), SystemInformationBlockType1 (“SIB1”), SystemInformationBlockType2 (“SIB2”), Subscriber Identity/Identification Module (“SIM”), Signal-to-Interference-Plus-Noise Ratio (“SINR”), Sidelink (“SL”), Service Level Agreement (“SLA”), Service Level Specification (“SLS”), Self-Organizing Networks (“SON”), Sidelink Synchronization Signals (“SLSS”), Session Management (“SM”), Session Management Function (“SMF”), Service Management and Orchestration (“SMO”), Secondary Node (“SN”), Special Cell (“SpCell”), Single Network Slice Selection Assistance Information (“S-NSSAI”), Semi-Persistent Scheduling (“SPS”), Scheduling Request (“SR”), Signaling Radio Bearer (“SRB”), Shortened TMSI (“S-TMSI”), Shortened TTI (“sTTI”), Synchronization Signal (“SS”), Survival Time (“ST”), Sidelink CSI RS (“S-CSI RS”), Sidelink PRS (“S-PRS”), Sidelink SSB (“S-SSB”), Synchronization Signal Block (“SSB”), Subscription Concealed Identifier (“SUCI”), Scheduling User Equipment (“SUE”), Supplementary Uplink (“SUL”), Subscriber Permanent Identifier (“SUPI”), Support Vector Machine (“SVM”), Tracking Area (“TA”), TA Identifier (“TAI”), TA Update (“TAU”), Timing Alignment Timer (“TAT”), Transport Block (“TB”), Transport Block Size (“TBS”), Transmission Configuration Indicator (“TCI”), Time-Division Duplex (“TDD”), Time Division Multiplexing (“TDM”), Time Division Orthogonal Cover Code (“TD-OCC”), Time Domain Resource Allocation (“TDRA”), Transport Layer Security Public Key Infrastructure (“TLS-PKI”), Temporary Mobile Subscriber Identity (“TMSI”), Time of Flight (“ToF”), Transmission Power Control (“TPC”), Transmission and Reception Point (“TRP”), Time Sensitive Communication (“TSC”), Time Sensitive Assistance Information (“TSCAI”), Time Sensitive Networking (“TSN”), Transmission Time Interval (“TTI”), Transmit (“TX”), Unmanned Aircraft System (“UAS”), Uplink Control Information (“UCI”), Unified Data Management Function (“UDM”), Unified Data Repository (“UDR”), User Entity/Equipment (Mobile Terminal) (“UE”) (e.g., a V2X UE), UE Autonomous Mode (UE autonomous selection of V2X communication resource—e.g., Mode-2 in NR V2X and Mode-4 in LTE V2X. UE autonomous selection may or may not be based on a resource sensing operation), Uplink (“UL”), UL SCH (“UL-SCH”), Universal Mobile Telecommunications System (“UMTS”), User Plane (“UP”), UP Function (“UPF”), Uplink Pilot Time Slot (“UpPTS”), Uniform Resource Identifier (“URI”), Uniform Resource Locator (“URL”), Ultra-reliability and Low-latency Communications (“URLLC”), UE Route Selection Policy (“URSP”), Vehicle-to-Vehicle (“V2V”), Vehicle-to-Everything (“V2X”), V2X Control Function (“V2XCF”), V2X UE (e.g., a UE capable of vehicular communication using 3GPP protocols), V2X Application Enabler (“VAE”), Visiting AMF (“vAMF”), Virtual Network Function (“VNF”), Visiting NSSF (“vNSSF”), Visiting PLMN (“VPLMN”), Virtual Reality (“VR”), Wide Area Network (“WAN”), and Worldwide Interoperability for Microwave Access (“WiMAX”).

In certain wireless communications networks, application programming interfaces may be used.

### BRIEF SUMMARY

Methods for application programming interface translation are disclosed. Apparatuses and systems also perform the functions of the methods. One embodiment of a method includes receiving a request for invoking a service application programming interface. In some embodiments, the method includes translating the service application programming interface to a slice application programming interface. In various embodiments, the method includes invoking the translated slice application programming interface.

One apparatus for application programming interface translation includes a receiver that receives a request for invoking a service application programming interface. In various embodiments, the apparatus includes a processor that: translates the service application programming interface to a slice application programming interface; and invokes the translated slice application programming interface.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for application programming interface translation;

FIG. 2 is a schematic block diagram illustrating one embodiment of an apparatus that may be used for application programming interface translation;

FIG. 3 is a schematic block diagram illustrating another embodiment of an apparatus that may be used for application programming interface translation;

FIG. 4 is a communications diagram illustrating one embodiment of communications for application programming interface translation;

FIG. 5 is a communications diagram illustrating another embodiment of communications for application programming interface translation;

FIG. 6 is a communications diagram illustrating a further embodiment of communications for application programming interface translation;

FIG. 7 is a communications diagram illustrating yet another embodiment of communications for application programming interface translation;

FIG. 8 is a communications diagram illustrating yet a further embodiment of communications for application programming interface translation; and

FIG. 9 is a flow chart diagram illustrating one embodiment of a method for application programming interface translation.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

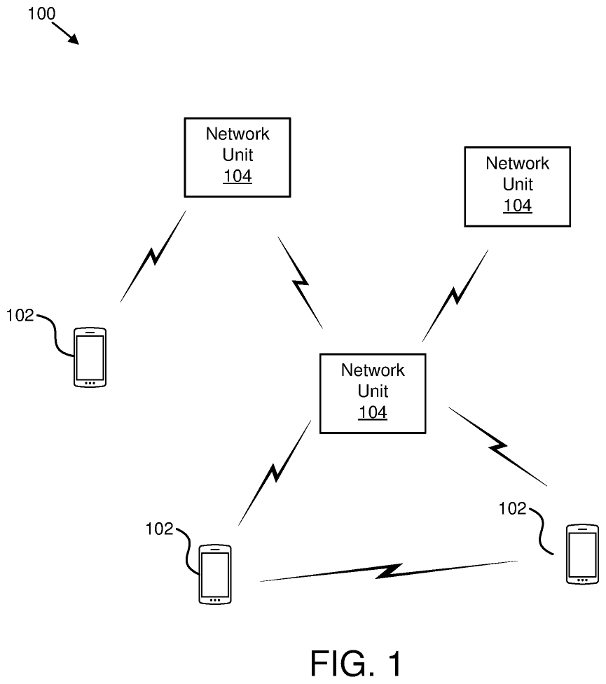

FIG. 1 depicts an embodiment of a wireless communication system 100 for application programming interface translation. In one embodiment, the wireless communication system 100 includes remote units 102, and network units 104. Even though a specific number of remote units 102, and network units 104 are depicted in FIG. 1, one of skill in the art will recognize that any number of remote units 102, and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a Node-B, an eNB, a gNB, a Home Node-B, a relay node, a device, a core network, an aerial server, a radio access node, an AP, NR, a network entity, an AMF, a UDM, a UDR, a UDM/UDR, a PCF, a RAN, an NSSF, an OAM, an SMF, a UPF, an application function, an application enabler server, a cloud-native function, a MEC function, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an OFDM modulation scheme on the DL and the remote units 102 transmit on the UL using a SC-FDMA scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive a request for invoking a service application programming interface. In some embodiments, the network unit 104 may translate the service application programming interface to a slice application programming interface. In various embodiments, the network unit 104 may invoke the translated slice application programming interface. Accordingly, the network unit 104 may be used for application programming interface translation. As used herein, a management entity may refer to any entity that manages another entity or device (e.g., a management entity may be a management domain, vendor device, vendor solution 5GS operator domain, 3GPP core, 3GPP RAN, cloud domain, datacenter, transport network, operator administrative domain, country domain, LCM, FCAPS management, API management, and so forth). Moreover, as used herein a managed entity may refer to any entity that is managed by another entity or device (e.g., a managed entity may be: API, CS, NSI, NSSI, network functions or other resources in telecom networks such as virtualized network function and/or physical entities such as PNFs).

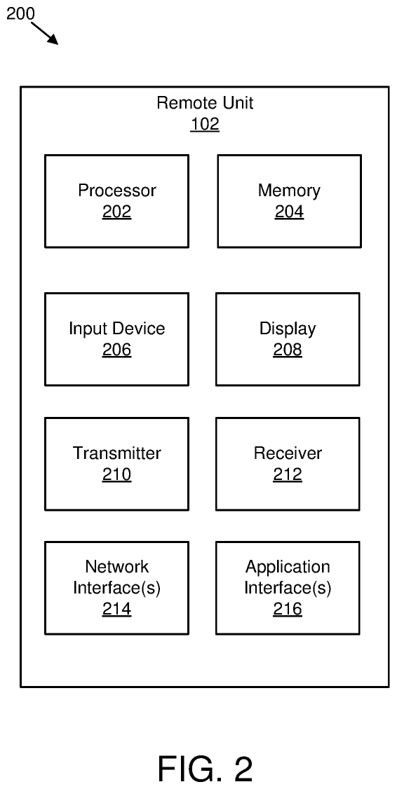

FIG. 2 depicts one embodiment of an apparatus 200 that may be used for application programming interface translation. The apparatus 200 includes one embodiment of the remote unit 102. Furthermore, the remote unit 102 may include a processor 202, a memory 204, an input device 206, a display 208, a transmitter 210, a receiver 212, one or more network interfaces 214, and one or more application interfaces 216. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

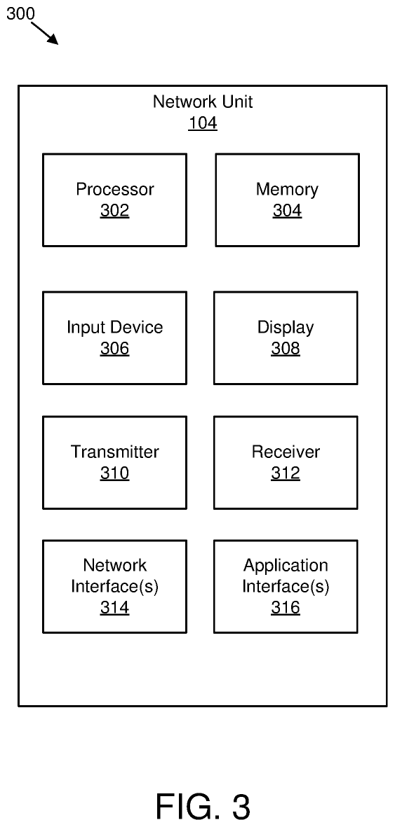

FIG. 3 depicts another embodiment of an apparatus 300 that may be used for application programming interface translation. The apparatus 300 includes one embodiment of the network unit 104. Furthermore, the network unit 104 may include a processor 302, a memory 304, an input device 306, a display 308, a transmitter 310, a receiver 312, one or more network interfaces 314, and one or more application interfaces 316. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In various embodiments, the receiver 312 may receive a request for invoking a service application programming interface. In certain embodiments, the processor 302 may: translate the service application programming interface to a slice application programming interface; and invoke the translated slice application programming interface.

In certain embodiments, network slicing is a key feature (e.g., 5G). In such embodiments, network slicing may introduce logical end-to-end sub-networks corresponding to different verticals. In some embodiments, network slicing may enable the deployment of multiple logical networks known as network slice instances offering 3rd parties and verticals customized communication services on the top of a shared infrastructure. In various embodiments, based on a physical network that might be operated by a public operator or an enterprise, 5G may provide the means to run multiple slices for different communication purposes. In certain embodiments, 5G may enable slices to be independently run and/or isolated from one another.

In some embodiments, a network slice instance (e.g., private or public slice) may include a RAN part and/or a CN part. In various embodiments, a sub-part of a network slice instance may be called a network slice subnet instance (NSSI) which may contain further NSSI.

In certain embodiments, there may be application support for slices, such as in 3GPP 5GS. An application, as used herein, refers to an application function, an application server, an application client, an application enabler server, an application enabler client, a vertical application specific server, a vertical application specific client, and/or an API invoker. Such terms may be understood in 3GPP and/or may be defined in TS23.434, TS 23.222, TS 23.558, TS 23.286, and/or TS 23.501. In some embodiments, an application may use any one of the following managed entities: CS, NSI, NSSI, network functions or other resources in telecom networks such as virtualized network function and/or physical entities such as PNFs. In some embodiments, an application may provide network related optimizations using analytics (e.g., such as from a RIC platform).

In various embodiments, network slice instance configuration and provisioning may include information related to exposure of capabilities to a slice customer, vertical, and/or tenant. For example, this information may be related to a control plane for a particular slice or a session within a slice (e.g., via SCEF/NEF). This may include network slice analytics from NWDAF and/or traffic steering and/or QoS influence by an application for a user within a slice. As another example, this information may be related to a management plane for particular slices or slice subnets (e.g., RAN, CN). This may be related to NSI and/or NSSI modification or monitoring by a customer based on a SLS. In some embodiments, an SLS may form part of an SLA and/or may quantify a minimum acceptable standard of service required.

Exposure capabilities (e.g., which may be slice-specific or slice-aware) may use APIs between a 5GS and applications deployed by a network slice customer. For control plane interactions, this may be performed via NEF and/or SCEF northbound APIs, and, for management service exposure, this may be performed via MEF and/or EGMF APIs. As found herein, a service API may be an interface through which a component of a system exposes its services to API invokers by abstracting the services from underlying mechanisms. Moreover, a slice API may be a customized set or combination of service APIs that abstract services for a particular slice of a network based on a slice capability exposure.

In some embodiments, there may be API portability across vendors and/or multiple vendors (e.g., multi-vendor). In certain embodiments, a 5GS may be multi-vendor (e.g., with multiple control and management planes that may be virtualized in different cloud platforms), and APIs may be offered by different 5GS termination points.

In a first example, a vertical customer may simultaneously use services offered by multiple networks or services provided by different vendors' systems within the same operator network (e.g., E2E management system from vendor A, RAN management system from vendor B, core network CP vendor C, core network UP vendor D). If a vertical customer interacts with such a multi-vendor system via APIs, the vertical customers' applications may need to be aware of the API offering and network domains information.

In a second example, some applications of a vertical customer may be deployed (or migrated) to different cloud platforms (e.g., for V2X scenario—some applications of automaker X may be relocated at an edge cloud connected to CN-U A while other applications are deployed at the regional cloud connected to CN-U B). In such an example, for consuming management and control services, APIs may be configured towards applications of the same vertical in a different way. This may include API info (e.g., termination points), as well as API protocols (e.g., to ensure meeting the latency requirements).

In certain embodiments, control and management services may be related to slicing and may be highly dependent upon slicing.

In such embodiments, in slicing, the control and management related services may have strong coupling (e.g., since the slice management affects the control plane and vice versa) and at the same time a slice customer may have dynamic and/or on-demand requests that affect both of the control and management plane.

In a first example, RAN NSSI high load and/or resource unavailability may affect per UE slice parameters. The slice customer may require control plane adaptation (e.g., resource adaptation, traffic steering, app to slice re-mapping) based on a management plane event.

In a second example, a group UE mobility may affect slice RRM policies for one or more cell areas (e.g., as configured by an OAM without considering UE behavior).

In various embodiments, simplifying APIs may enable flexible and/or dynamic interactions between a slice customer and a provider. In such embodiments, the slice customer may not want to understand specific MNO- provisioned network parameters (e.g., related to services to be exposed), but may require an output that is understandable (e.g., an alert from an MNO, an instruction for more resources and/or more UPFs). At the same time the MNO may want to hide a network topology while providing required information to the slice customer.

In some embodiments, if a slice customer wants to request a new and/or modified service on-demand, negotiation may be made between an MNO and an ASP to map a service to API requirement (e.g., management, control). This may require a service exposure modification that may result in a new API or a modification of a current API. More specifically, if an application server intends to invoke an API for consuming a service related to a used (or subscribed) slice, applications of a slice customer may need to be aware of services mapped to each slice, as well as a level of exposure and termination points for APIs. If a new request requires new or modified APIs, time consuming negotiations and/or signaling may be used to set and/or configure the new and/or modified services and APIs. For the APIs, applications may be compatible with API versions, protocols, communication types, and so forth.

In certain embodiments, APIs may be dynamically provisioned, available, and/or simple for allowing vertical apps to flexibly consume services without requiring complex and/or time-consuming interactions with the MNO.

In some embodiments, there may be slice access with an application preference. In such embodiments, applications (e.g., gaming or online video applications) may access a 5GS over multiple slices for different services (e.g., based on a user membership), or may have different priorities for different slices based on an ASP request. Different slices in such embodiments may be available in all provided frequencies or a sub-set of them (e.g., FR1 or FR2 only) based on MNO and ASP agreement (e.g., and network capabilities to support a slice requirement). As an example, a mobile network operator may provision a set of network slices (e.g., Slice #1, Slice #2, Slice #3) which may be used by different ASPs (e.g., Slice #1 for online video services, Slice #2 for gaming, Slice #3 for eMBB or IOT service). Different ASPs may use these slices (or a subset of them) for different services that they offer. Furthermore, if an application changes network slices to be accessed, it may be agnostic to the UEs accessing the service and may be performed automatically.

In one example, Users A and B (e.g., who include UE1 and UE2 respectively) have installed game applications and video applications which may have high priorities based on their membership to the video and game services. This may enable them to connect automatically to Slice #1 and Slice #2 to guarantee their QoS compared with other users with a lower priority. The priority over the slices to be used by UEs #1 and #2 may change based on an ASP request (e.g., UE moves to a different service area or an area where a certain frequency is not available, different slice load conditions, or 3rd party ASP rolls out new services and/or applications and the user membership changes).

To allow for such ASP-provided changes, a slice capability exposure may be used for influencing control plane (e.g., for requesting session-related adaptations such as DNN remapping and/or slice re-mapping) and management plane (e.g., adaptation of NSI and/or NSSI parameters like RRM policies or coverage). This may be done via APIs from both control and management plane (e.g., in an uncoordinated manner). In this example, a vertical application may need to know which entity offers which APIs and what protocol requirements there are for API consumption. As used herein, a slice capability exposure (e.g., a level of abstraction and/or permissions over an exposed slice tailored services and/or capabilities) may be a means to securely expose the services and capabilities related to a network slice, based on the per slice service-level agreement between the network slice provider and the network slice consumer (e.g., slice customer of the MNO), while a service capability exposure (e.g., a level of abstraction and/or permissions over exposed services and/or capabilities) may be a means to securely expose the services and capabilities provided by network interfaces based on the service-level agreement between the network service provider and the network service consumer (e.g. customer of the MNO).

Described herein may be various embodiments of exposing slice capabilities (e.g., control and/or management) to applications of a vertical customer (e.g., which may be deployed centrally or distributed over different clouds).

In some embodiments, an application support layer may be used for vertical applications (e.g., vertical application enabler layer) which may act as a middleware for exposing northbound APIs to verticals as well as to provide some server-client support functionalities for connected devices.

In various embodiments, there may be a mechanism to allow an enabler server to perform slice re-mapping for a V2X application and involved UEs in response to a trigger by a change of application requirements.

In certain embodiments, SEAL may use a service (e.g., network slice enabler), which may have a server and client application counterpart. In some embodiments, an NSE layer may provide a network slice adaptation and/or migration capability for all devices running an application. Such embodiments may require interaction between an OAM and NSE server as well as the NSE server and an NSE client at a device side (e.g., for applying slice adaptation).

Some embodiments may use a CAPIF to enable a unified northbound API framework across 3GPP network functions and/or to ensure that there is a single and harmonized approach for API development. Some functionalities in CAPIF may include: 1) CCF which may function as a repository of all (e.g., PLMN and 3rd party) service APIs; 2) AEF which may be a provider of services as APIs; and/or 3) an API invoker which may be used for applications that require service from service providers.

As used herein, non-RT RIC may mean: a logical function that enables non-real-time control and optimization of RAN elements and resources, AI/ML workflow including model training and updates, and policy-based guidance of applications and/or features in Near-RT RIC.

Moreover, as used herein, near-RT RIC and framework functions may mean: a logical function that enables near-real-time control and optimization of RAN elements and resources via fine-grained (e.g., UE basis, cell basis) data collection and actions over an E2 interface. Near-RT RIC may include near-RT RIC basic and/or framework functions which may include subscription management, conflict mitigation, E2 termination (“E2T”), and/or management services.

Furthermore, as used herein, management Services of an RIC platform may include Life-Cycle Management (“LCM”) of an xApp and/or fault, configuration, accounting, performance, security (“FCAPS”) management of Near-RT RIC. These services may be provided by a near-RT RIC to an xApp (e.g., via Open API) or from an SMO (Non-RT RIC) to xApps (via O1).

An xApp as used herein may mean: an application designed to run on a Near-RT RIC. Such an application may be likely to include one or more microservices and at a point of on-boarding may identify which data it consumes and which data it provides. The xApp application is independent of a Near-RT RIC and may be provided by any third party. E2 may enable a direct association between the xApp and RAN functionality.

Moreover, as used herein rApp may mean: an application similar to xApp which is designed to run on a Non-RT RIC. Furthermore, A1 may be an interface between non-RT RIC and Near-RT RIC to enable policy-driven guidance of Near-RT RIC applications and/or functions, and may support AI and/or ML workflow. E2 may refer to an interface connecting a Near-RT RIC and a NR system. Moreover, O1 may refer to an interface between orchestration & management entities and O-RAN managed elements.

In various embodiments, an E2 Node may be a logical node terminating an E2 interface. Moreover, in some embodiments, open API may be an interface between framework functions and xAPPs.

In some embodiments, open API and/or O-RAN API may refer to an interface between framework functions and xAPPs.

In certain embodiments, API management services may enable a RIC platform to provide support for O-RAN APIs (e.g., O-RAN APIs may be defined as open APIs within an O-RAN scope) which may be provided by either a RIC framework or xApps in a service-based manner. In particular, API management services may include: repository and/or registry services for the O-RAN APIs, services that enable discovery of registered O-RAN APIs, services to authenticate xApps for use of O-RAN APIs, and/or services that enable generic subscription and event notification.

In various embodiments, API management services may be accessed via an xApp enablement API by xApps for supporting API discovery, providing authentication, and generic subscription and event notification.

In some embodiments, an application support layer may be used for vertical applications (e.g., known as vertical application enabler layer) which may act as a middleware for exposing northbound APIs to verticals as well as to provide some server-client support functionalities for the connected devices.

In various embodiments, ETSI MEC may enable exposure of APIs from RAN to MEC platforms. The exposure of APIs from UE and/or RAN to a service provider may relate to UE location information, bandwidth management, and/or RNI. In certain embodiments, there may be RNI API exposure from a RAN to a MEC. More specifically, RNIS may be a service that provides radio network related information to MEC applications and to MEC platforms. The granularity of radio network information may be adjusted based on parameters such as information per cell, per user equipment, per QoS class, and/or it may be requested over a period of time. The RNI may be used by MEC applications and a MEC platform to optimize existing services and/or to provide new types of services that are based on up to date information on radio conditions.

In certain embodiments, an EES provides supporting functions needed for edge application servers and edge enabler clients, such as: 1) provisioning of configuration information to EECs thereby enabling exchange of application data traffic with the edge application server; 2) interacting with a 3GPP core network for accessing capabilities of network functions either directly (e.g., via PCF) or indirectly (e.g., via SCEF, NEF, and/or SCEF+NEF); and/or 3) supporting external exposure of 3GPP network capabilities to the edge application servers (e.g., over EDGE-3).

An EEC may provide supporting functions needed for application clients, such as retrieving and providing configuration information to enable the exchange of application data traffic with an edge application server and/or discovering edge application servers available in an edge data network. An ECS may provide supporting functions needed for an EEC to connect with an EES. These functionalities of an ECS may be related to providing edge configuration information to the EEC, which may be used for establishing a connection with the EES.

An EAS may be an application server resident in an edge data network that performs server functions. An AC may be an application resident in a UE performing a client function.

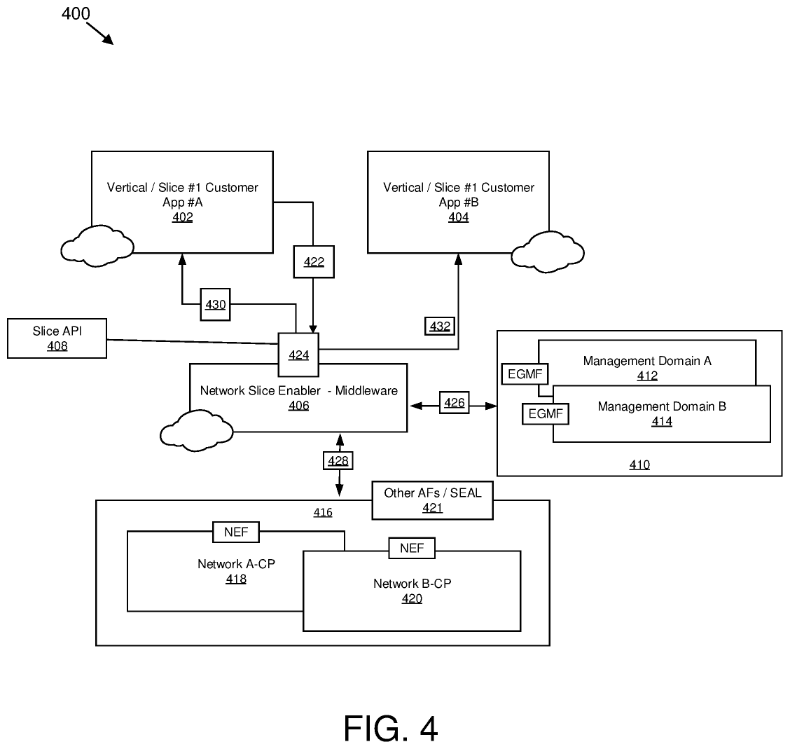

FIG. 4 is a communications diagram illustrating one embodiment of communications 400 for application programming interface translation. The communications 400 involve communications transmitted between a vertical/Slice #1 consumer application #A 402, a vertical/Slice #1 consumer application #B 404, a network slice enabler—middleware 406, a slice API 408, management domains 410 (e.g., including management domain A 412 and management domain B 414), control plane domains 416 (e.g., including network A-CP 418 and network B-CP 420), and other AFs/SEAL 421. As may be appreciated, each of the communications 400 described herein may include one or more messages.

The network slice enabler—middleware 406 (e.g., or network entity) may be configured to: A) translate a service API as invoked by the end applications to slice APIs based on an API configuration and application to slice mapping (e.g., receive 422 a service API invocation request from the vertical application—such as a service API being requested to 1) monitor SLA; 2) monitor expected QoS events; or 3) monitor a need for more UPFs, and to map 424 the service request to a slice API based on the determined API mapping—such as translating to perform: NSI monitoring from MD #1, NSSI Monitoring from MD #2, network and/or QoS monitoring from NEF #1, UPF load monitoring from NEF #2, and/or slice or UP analytics from NWDAF #1). In some embodiments, mapping 424 may assume that a service to slice mapping may be known at an entity (e.g., middleware). Such mapping knowledge may be pre-configured or provided by an MNO and/or MD in advance.

The network slice enabler—middleware 406 may in communications 426 and 428 consume and/or process services (e.g., any services exposed by an underlying telco infrastructure—such as management services, control services, and/or AF provided services) on behalf of vertical applications 402 and/or 404 based on agreed service exposure. In one example, the network slice enabler—middleware 406 may request and/or receive NSI Monitoring from MD #1, NSSI Monitoring from MD #2, network and/or QoS monitoring from NEF #1, and/or slice analytics from NWDAF #1.

The network slice enabler—middleware 406 may in communications 430 and 432 expose the services (e.g., management, control, AF, and/or value-added middleware services) to the vertical applications 402 and/or 404 based on the agreed level of exposure. In particular, the network slice enabler—middleware 406 may send a service API invocation response to the vertical applications 402 and/or 404 including API information and optionally additional capabilities that may be offered via requested APIs (e.g., provided by middleware). In one example, the network slice enabler—middleware 406 may post expected QoS events or recommendations to change application behavior (e.g., automation level), or access a request for more UPFs.

As illustrated in FIG. 4: the vertical/Slice #1 consumer application #A 402 and/or the vertical/Slice #1 consumer application #B 404 may have deployed applications in different cloud platforms (e.g., regional cloud and/or an edge cloud); the network slice enabler—middleware 406 (e.g., network or application entity, network slice enabler, middleware, AF, NF, MF) may be deployed at an edge cloud, regional cloud, core cloud, and/or a 3rd party cloud); the management domains 410 (e.g., one or more MDs) may interact with a proposed entity (e.g., via EGMF); the control plane domains 416 (e.g., one or more control plane domains) that interact with the proposed entity via NEF; and/or other AFs/SEAL 421 (e.g., one or more SEAL servers or AFs) that interact with the proposed entity for allowing the exposure of SEAL and/or AF provided services.

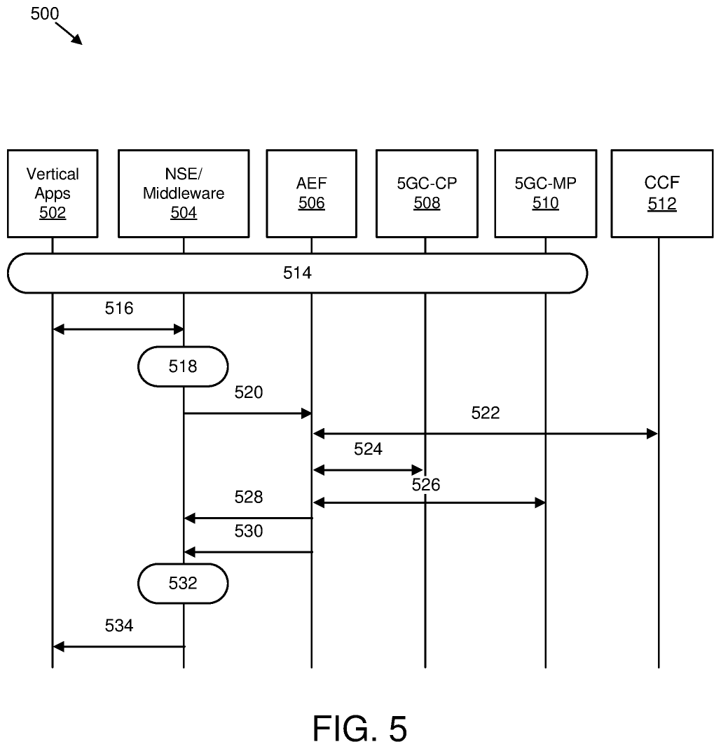

FIG. 5 is a communications diagram illustrating another embodiment of communications 500 for application programming interface translation. The communications 500 include communication between vertical apps 502 (e.g., vertical applications), NSE/middleware 504, AEF 506 (e.g., may be part of NSE), 5GC-CP 508 (e.g., NEF), 5GC-MP 510 (e.g., EGMF), and CCF 512 (e.g., may be part of NSE). As may be appreciated, each of the communications 500 described herein may include one or more messages.

FIG. 5 includes embodiments in which the NSE/middleware 504 may be middleware including an enabler server (e.g., NSE or any other vertical enabler server).

In a first communication 514 transmitted between the vertical apps 502, the NSE/middleware 504, the AEF 506, the 5GC-CP 508, and the 5GC-MP 510, mapping of slice APIs to service APIs may be pre-configured (e.g., statically in a plugin for a respective vendor domain).

In a second communication 516 transmitted between the vertical apps 502 and the NSE/middleware 504, the vertical applications 502 (e.g., of a network slice customer) may send a service API invocation request to the NSE/middleware 504. The service API invocation request may include one or more of the following parameters: an API invoker identification (e.g., vertical application ID); authorization information (e.g., if obtained before invocation request); a service API identification; service API information (e.g., name, type, communication methods, protocols); and/or a preferred slice identification (e.g., preferred S-NSSAI and/or NSSAI, slice profile ID). The NSE/middleware 504 may send back a response with feedback (e.g., a positive or negative acknowledgment). The feedback may indicate the success or failure of the service API invocation request. In some embodiments, the response may be sent back as part of the second communication 516, after authorization by the CCF 512, or together with an API invocation (e.g., in step 534).

The NSE/middleware 504 may map 518 the service API invocation to a slice API based on the configuration mapping (e.g., from step 514).

In a third communication 520 transmitted from the NSE/middleware 504 to the AEF 506, the NSE/middleware 504 sends a slice API invocation request to the corresponding AEF 506. In certain embodiments, the AEF 506 is part of the NSE/middleware 504. The slice API invocation request may include one or more of the following parameters: an AEF ID or a middleware ID (e.g., slice API invoker identification); a vertical application ID (e.g., original requester of the service API); authorization information (e.g., if obtained before the invocation request); a slice API identification; and/or slice API information (e.g., name, type, communication methods, protocols).

In a fourth communication 522 transmitted between the AEF 506 and the CCF 512, the AEF 506 optionally requests and receives an authorization for the slice API invocation and access control. In some embodiments, the CCF 512 is part of the NSE/middleware 504. The authorization may include an authorization request from the AEF 506 to the CCF 512 to get security information. The authorization request may include the slice API invoker information. Security information may relate to a chosen security method (e.g., TLS-PKI) for transmission to the AEF 506 over a CAPIF-3 reference point. The CCF 512 may return an API invoker's root CA certificate for the AEF 506 to validate the slice API invoker's certificate. After fetching the relevant security information for the authentication, the AEF 506 may send an authentication initiation response message to an API invoker to initiate a TLS session establishment procedure.

In a fifth communication 524 transmitted between the AEF 506 and the 5GC-CP 508 and/or a sixth communication 526 transmitted between the AEF 506 and the 5GC-MP 510, the AEF 506 consumes the related services (e.g., control or management) via NEF APIs, MEF APIs, and/or EGMF APIs. This fifth communication 524 may include services provided by SEAL servers (e.g., GMS, LMS, and so forth) or other AFs, such as: control plane related services exposed via NEF; management plane related services exposed via EGMF; and/or SEAL and/or AF services provided via SEAL APIs and/or AF APIs.

In a seventh communication 528 transmitted from the AEF 506 to the NSE/middleware 504, the AEF 506 sends a slice API invocation response to the middleware which may be a positive or negative acknowledgement. This API may also include information on the services to be consumed by the NSE/middleware 504 related to slice #x. The seventh communication 528 may include the result (e.g., positive acknowledgement, negative acknowledgement), a list of available service APIs within the slice APIs and their information (e.g., ID, name, type, protocol, communication method, access policies).

In an eighth communication 530 transmitted from the AEF 506 to the NSE/middleware 504, the AEF 506 sends information corresponding to consumption of the services to be exposed (e.g., via the service APIs within the slice API).

The NSE/middleware 504 determines 532 the service capability exposure that is to be provided to the vertical apps 502. This is based on the requirement in the second communication 516, as well as the consumed services in the seventh communication 528 and/or the eighth communication 530.

In a nineth communication 534 transmitted from the NSE/middleware 504 to the vertical applications 502, the NSE/middleware 504 exposes the services (e.g., which may be control, management, and/or a middleware-provided value-added service) to the vertical applications 502.

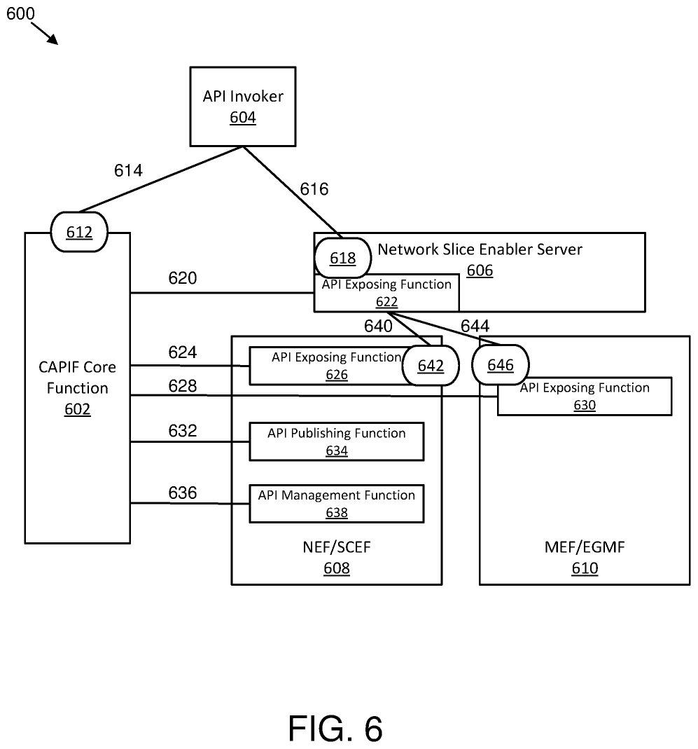

FIG. 6 is a communications diagram illustrating a further embodiment of communications 600 for application programming interface translation. The communications 600 includes communication between a CAPIF core function 602, an API invoker 604 (e.g., of slice #x), a network slice enabler server 606, an NEF/SCEF 608, and an MEF/EGMF 610. As may be appreciated, each of the communications 600 described herein may include one or more messages.

CAPIF APIs 612 may communicate over CAPIF-1 614 with the API invoker 604, and the API invoker 604 may communicate over CAPIF-2 616 with service APIs 618. The CAPIF core function 602 may communicate over CAPIF-3 620 with an API exposing function 622 (“AEF-0”). Further, the CAPIF core function 602 may communicate over CAPIF-3 624 with an API exposing function 626 (“AEF-1”). Moreover, the CAPIF core function 602 may communicate over CAPIF-3 628 with an API exposing function 630 (“AEF-2”). The CAPIF core function 602 may communicate over CAPIF-4 632 with an API publishing function 634. Further, the CAPIF core function 602 may communicate over CAPIF-5 636 with an API management function 638. Moreover, the API exposing function 622 may communicate over CAPIF-7 640 with slice X control APIs 642. The API exposing function 622 may communicate over CAPIF-7 644 with slice X management APIs 646.

In certain embodiments, NSE/middleware (e.g., network slice enabler server 606) and AEF may be the same or different entities based on an implementation (e.g., AEF may be part of NEF). The AEF may determine the exposure layer for exposing APIs, and the NSE/middleware functionality may provide slice API to service API mapping configuration retrieval. In some embodiments, the NSE/middleware may have AEF functionality (e.g., AEF-0) and another AEF may be used per type of API (e.g., AEF-1 for management plane and AEF-2 for control plane) as illustrated in FIG. 4.

In some embodiments, there may be an implementation for MEC deployments. In such embodiments, a slice enabling service may be a module and/or function at an edge cloud platform. This may be an EES, an ECS, or may be a slice enabling MEC platform capability function which is required for exposing services to verticals in a slice tailored manner.

In various embodiments, it may be assumed that a slice enabling service is activated and that a vertical application is aware of information for accessing it for invoking service APIs (e.g., assuming that the vertical application has discovered the slice enabling service). In certain embodiments, a MEC platform internally routes a service API request to a slice enabling service.

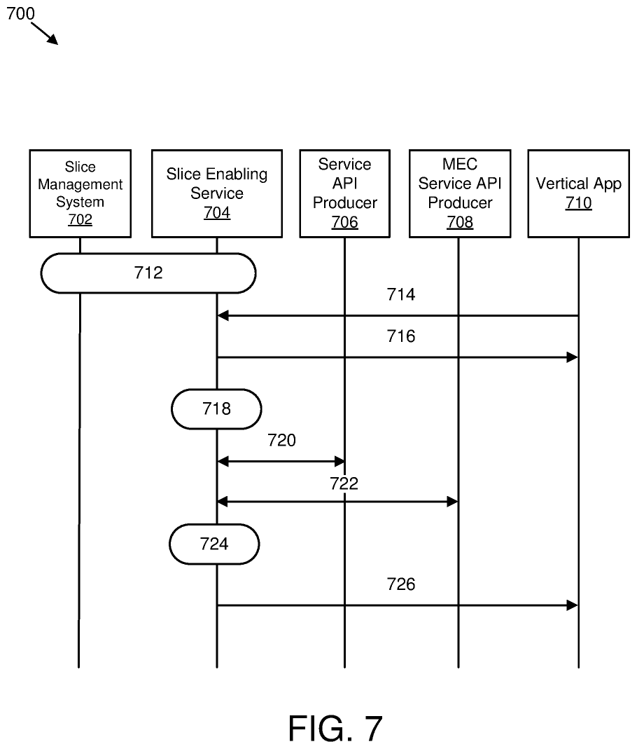

FIG. 7 is a communications diagram illustrating yet another embodiment of communications 700 for application programming interface translation. The communications 700 include communication between a slice management system 702, a slice enabling service 704 (e.g., MEC platform function, EES, EEC), a service API producer 706 (e.g., MNO-provided service API producer, NEF, EGMF, SEAL, AF), an MEC service API producer 708, and a vertical app 710 (e.g., EAS, AC). As used herein, app and application may be used interchangeably and may both refer to an application. As may be appreciated, each of the communications 700 described herein may include one or more messages.

In a first communication 712 transmitted between the slice management system 702 and the slice enabling service 704, a slice API to service API mapping may be determined (e.g., based on service capability exposure). The mapping of slice APIs to service APIs may be pre-configured (e.g., statically in a plugin for a respective vendor domain).

In a second communication 714 transmitted from the vertical application 710 to the slice enabling service 704, the vertical application 710 (e.g., of a network slice customer) may send a service API invocation request to the slice enabling service 704. The service API invocation request may include one or more of the following parameters: an API invoker identification (e.g., vertical application ID, EAS ID, AC ID); authorization information (e.g., if obtained before the invocation request); a service API identification; service API information (e.g., name, type, communication methods, protocols); and/or a preferred slice identification (e.g., preferred S-NSSAI/NSSAI, slice profile ID).

In a third communication 716 transmitted from the slice enabling service 704 to the vertical application 710, the slice enabling service 704 maps the service API invocation to a slice API based on the configuration mapping (e.g., from the first communication 712).

The slice enabling service 704 translates 718 the service API (e.g., RNI API) to the corresponding slice API (e.g., Slice #x API) based on the configuration of the mapping (e.g., may be pre-configured). Then, the slice enabling service 704 optionally requests and receives an authorization for the slice API invocation and access control from a slice API authorizing function (e.g., CCF, API management function, or an MD function). The authorization may include security information and certification of the slice enabling service 704 to translate the service API to slice API.

In a fourth communication 720 transmitted between the slice enabling service 704 and the service API producer 706 and/or a fifth communication 722 between the slice enabling service 704 and the MEC service API producer 708, the slice enabling service 704 consumes the related services (e.g., control or management) via NEF, MEF, EGMF, or MEC APIs. In certain embodiments, the fourth communication 720 may include services provided by SEAL servers (e.g., GMS, LMS) or other AFs such as: control plane related services exposed via NEF; management plane related services exposed via EGMF; MEC and/or EES services (e.g., RNIS, bandwidth service, location service) exposed via APIs; and/or SEAL and/or AF services provided via SEAL and/or AF APIs. In some embodiments, if the slice enabling service 704 is part of a EEC at the device side, some service APIs may be consumed indirectly via a corresponding EES. F or example, for control APIs, the EEC may request from EES and/or the EES may request from NEF).

The slice enabling service 704 determines 724 the service capability exposure which is to be provided to the vertical application 710. This may be based on the second communication 714, as well as the consumed services in the fourth communication 720 and/or the fifth communication 722. An abstraction of one or more services may be provided as a value added service by the slice enabler. One example may be the generation of slice tailored analytics by the slice enabler server, taking as inputs a combination of analytics and/or measurements from MDAS, NWDAF, V2X AS, RNIS, and/or location services.

In a sixth communication 726 transmitted from the slice enabling service 704 to the vertical application 710, the slice enabling service 740 exposes the services (e.g., a control, a management, and/or a middleware-provided value-added service) to the vertical application 710.

In various embodiments, service API discovery may be performed by an xApp and/or rApp. In certain embodiments, xApp and/or rApp discover service APIs may be performed via API management services.

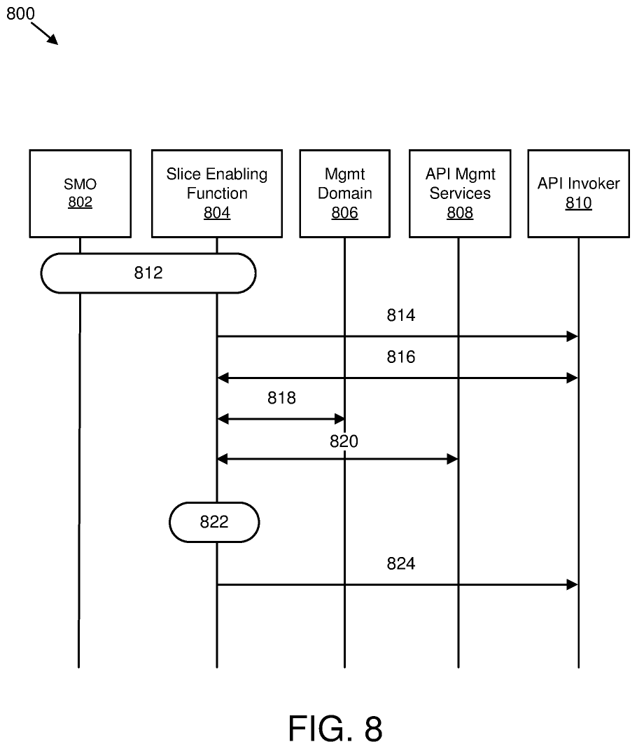

FIG. 8 is a communications diagram illustrating yet a further embodiment of communications 800 for application programming interface translation. The communications 800 include communication between an SMO 802, a slice enabling function 804 (e.g., xApp, rApp, RIC function), a management domain 806 (e.g., mgmt domain, API management services, SDL), API management services 808 (e.g., API mgmt services, E2 exposure layer, RIC), and an API invoker 810 (e.g., xApp, rApp). As used herein, mgmt and management may be used interchangeably and may both refer to management. As may be appreciated, each of the communications 800 described herein may include one or more messages.

In a first communication 812 transmitted between the SMO 802 and the slice enabling function 804, a slice API to service API mapping may be determined (e.g., based on service capability exposure). The mapping of slice APIs to service APIs may be pre-configured (e.g., statically in a plugin for a respective vendor domain).

In a second communication 814 transmitted from the slice enabling function 804 to the API invoker 810, the slice enabling function 804 advertises the service APIs to the API invoker 810. The advertisement includes an xApp/rApp identifier, a slice enabler function ID, a list of service APIs which are offered by an RIC platform, their mapping to available slices, availability, and/or load information (e.g., for a particular area, time, and/or communication service).

In a third communication 816 transmitted between the slice enabling function 804 and the API invoker 810, the API invoker 810 (e.g., of a network slice customer) sends a service API invocation request to the slice enabling function 804. This request includes one or more of the following parameters: an API invoker identification (e.g., xApp ID, rApp, vertical application ID, AF ID); authorization information (e.g., if obtained before the invocation request); a service API identification; service API information (e.g., name, type, communication methods, protocols); and/or a preferred slice identification (e.g., preferred S-NSSAI/NSSAI, slice profile ID). The slice enabling function 804 sends back a response with a positive or negative acknowledgment. The response indicates the success or failure of service API invocation. The response may be sent back either before a fourth communication 818 or together with the API invocation in a sixth communication 824.

In the fourth communication 818 transmitted between the slice enabling function 804 and the management domain 806, the slice enabling function 804 maps the service API invocation to a slice API based on the configuration mapping and consumes the related services (e.g., control, E2 related, management, database, SDL) via RIC control, RIC management, SDL services, and/or SDL functions.

In a fifth communication 820 between the slice enabling function 804 and the API management services 808, the control APIs are transmitted towards the E2 nodes (e.g., RAN entities) and includes exposure of radio parameters that may be either slice-based, RAN related, or UE related. These parameters may be measurements, may be trigger events, may be SON parameters, and/or RRM parameters.

The slice enabling function 804 determines 822 the service capability exposure which is to be provided to the API invoker 810. The slice enabling function 804 consumes the services of the fourth communication 818 and/or the fifth communication 820 and may provide a slice tailored abstraction combining both control and database services. An example may be the consumption of L2 measurements from E2 nodes, RAN NSSI monitoring reports from the management domain 806, and UE mobility prediction. Based on these, and the service to slice mapping, the slice enabling function 804 may provide to the API invoker 810 a slice congestion estimation for a particular time, area, and/or a prescription for an adaptation of the application behavior to avoid service disruption.

In a sixth communication 824 transmitted from a slice enabling function 804 to an API invoker 810, the slice enabling function 804 exposes the service (e.g., which may be a control, a management, and/or a middleware-provided value-added service) to the API invoker 810.

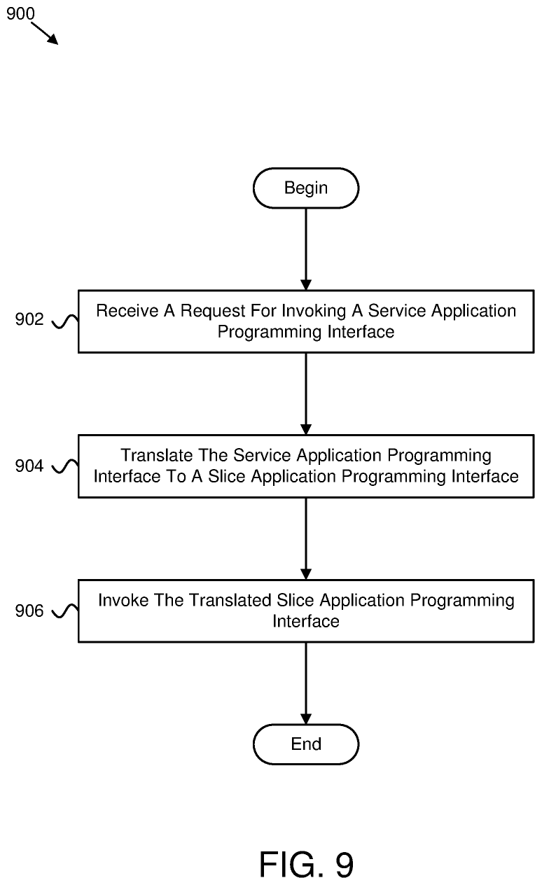

FIG. 9 is a flow chart diagram illustrating one embodiment of a method 900 for application programming interface translation. In some embodiments, the method 900 is performed by an apparatus, such as the network unit 104. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902 a request for invoking a service application programming interface. In some embodiments, the method 900 includes translating 904 the service application programming interface to a slice application programming interface. In various embodiments, the method 900 includes invoking 906 the translated slice application programming interface.

In one embodiment, a method 900 comprises: receiving a request for invoking a service application programming interface; translating the service application programming interface to a slice application programming interface; and invoking the translated slice application programming interface. In certain embodiments: receiving the request for invoking the service application programming interface comprises receiving a first service parameter from an application over the service application programming interface; translating the service application programming interface to the slice application programming interface comprises determining a second service parameter based on the first service parameter and a level of slice capability exposure; and invoking the translated slice application programming interface comprises transmitting the second service parameter to at least one service producer over the translated slice application programming interface.

In some embodiments, the method 900 further comprises transmitting a response to the at least one application after invoking the translated slice application programming interface. In various embodiments, the first service parameter comprises a network parameter, a network function parameter, a managed function parameter, a managed entity attribute, a management service parameter, an application parameter, a slice parameter, a service parameter, a general network slice template parameter, an upper layer parameter related to the application or the network, or some combination thereof. In one embodiment, the second service parameter comprises a network parameter, a network function parameter, a managed function parameter, a managed entity attribute, a management service parameter, an application parameter, a slice parameter, an entity provided parameter, a service parameter, a general network slice template parameter, an upper layer parameter related to the application or the network, or some combination thereof.

In certain embodiments, the first service parameter and the second service parameter are the same. In some embodiments, the application comprises at least one application located at an edge platform, a regional cloud platform, distributed over different cloud platforms, or some combination thereof. In various embodiments, the application comprises an application function, an application server, an application client, an application enabler server, an application enabler client, a vertical application specific server, a vertical application specific client, or a combination thereof.

In one embodiment, the slice application programming interface comprises at least one service application programming interface, at least a portion of one service application programming interface, or a combination thereof. In certain embodiments, the method 900 further comprises receiving slice information before receiving the request for invoking the service application programming interface, wherein the slice information comprises application to slice subscriptions, slice profiles, service profiles, slice exposure requirements, slice to service mapping, or some combination thereof. In some embodiments, the method 900 further comprises authorizing mapping the service application programing interface to the slice application programming interface before translating the service application programming interface to the slice application programming interface.

In various embodiments, the service application programming interface comprises a control application programming interface, a network exposure function application programming interface, a service capability exposure function application programming interface, a management application programming interface, a metro ethernet forum application programming interface, an exposure governance management function application programming interface, a management service application programming interface, a service enabler architecture layer application programming interface, an application function application programming interface, a mobile edge computing application programming interface, an open radio access network application programming interface, a radio access network intelligent controller application programming interface, or some combination thereof. In one embodiment, the method 900 further comprises subscribing to providers of the service application programming interface for consuming the service application programming interface after receiving the request for invoking the service application programming interface.

In certain embodiments, the method 900 is performed by an entity having the form of: a network slice enabler, a middleware, a slice enabling service, a slice enabling function, a mobile edge computing platform function, an edge enabler server, an edge enabler client, an xApp, an rApp, an API management service, a radio access network intelligent controller function, or some combination thereof. In some embodiments, the entity is executed on a cloud platform, an edge cloud platform as a platform capability function, or application. In various embodiments, invoking the translated slice application programming interface comprises making a translated slice application programming interface request to a service producer, receiving a translated slice application programming interface response from the service producer, or a combination thereof. As used herein, a service producer may be the provider of a first and/or second service parameter, and may be a network entity, an application entity, a management entity, and/or a cloud entity.

In one embodiment, a method comprises: receiving a request for invoking a service application programming interface; translating the service application programming interface to a slice application programming interface; and invoking the translated slice application programming interface.

In certain embodiments: receiving the request for invoking the service application programming interface comprises receiving a first service parameter from an application over the service application programming interface; translating the service application programming interface to the slice application programming interface comprises determining a second service parameter based on the first service parameter and a level of slice capability exposure; and invoking the translated slice application programming interface comprises transmitting the second service parameter to at least one service producer over the translated slice application programming interface.

In some embodiments, the method further comprises transmitting a response to the at least one application after invoking the translated slice application programming interface.

In various embodiments, the first service parameter comprises a network parameter, a network function parameter, a managed function parameter, a managed entity attribute, a management service parameter, an application parameter, a slice parameter, a service parameter, a general network slice template parameter, an upper layer parameter related to the application or the network, or some combination thereof.

In one embodiment, the second service parameter comprises a network parameter, a network function parameter, a managed function parameter, a managed entity attribute, a management service parameter, an application parameter, a slice parameter, an entity provided parameter, a service parameter, a general network slice template parameter, an upper layer parameter related to the application or the network, or some combination thereof.

In certain embodiments, the first service parameter and the second service parameter are the same.

In some embodiments, the application comprises at least one application located at an edge platform, a regional cloud platform, distributed over different cloud platforms, or some combination thereof.

In various embodiments, the application comprises an application function, an application server, an application client, an application enabler server, an application enabler client, a vertical application specific server, a vertical application specific client, or a combination thereof.

In one embodiment, the slice application programming interface comprises at least one service application programming interface, at least a portion of one service application programming interface, or a combination thereof.

In certain embodiments, the method further comprises receiving slice information before receiving the request for invoking the service application programming interface, wherein the slice information comprises application to slice subscriptions, slice profiles, service profiles, slice exposure requirements, slice to service mapping, or some combination thereof.

In some embodiments, the method further comprises authorizing mapping the service application programing interface to the slice application programming interface before translating the service application programming interface to the slice application programming interface.

In various embodiments, the service application programming interface comprises a control application programming interface, a network exposure function application programming interface, a service capability exposure function application programming interface, a management application programming interface, a metro ethernet forum application programming interface, an exposure governance management function application programming interface, a management service application programming interface, a service enabler architecture layer application programming interface, an application function application programming interface, a mobile edge computing application programming interface, an open radio access network application programming interface, a radio access network intelligent controller application programming interface, or some combination thereof.

In one embodiment, the method further comprises subscribing to providers of the service application programming interface for consuming the service application programming interface after receiving the request for invoking the service application programming interface.

In certain embodiments, the method is performed by an entity having the form of: a network slice enabler, a middleware, a slice enabling service, a slice enabling function, a mobile edge computing platform function, an edge enabler server, an edge enabler client, an xApp, an rApp, an API management service, a radio access network intelligent controller function, or some combination thereof.

In some embodiments, the entity is executed on a cloud platform, an edge cloud platform as a platform capability function, or application.

In various embodiments, invoking the translated slice application programming interface comprises making a translated slice application programming interface request to a service producer, receiving a translated slice application programming interface response from the service producer, or a combination thereof.

In one embodiment, an apparatus comprises: a receiver that receives a request for invoking a service application programming interface; and a processor that: translates the service application programming interface to a slice application programming interface; and invokes the translated slice application programming interface.

In certain embodiments, the apparatus further comprises a transmitter, wherein: the receiver receiving the request for invoking the service application programming interface comprises the receiver receiving a first service parameter from an application over the service application programming interface; the processor translating the service application programming interface to the slice application programming interface comprises the processor determining a second service parameter based on the first service parameter and a level of slice capability exposure; and the processor invoking the translated slice application programming interface comprises the transmitter transmitting the second service parameter to at least one service producer over the translated slice application programming interface.

In some embodiments, the transmitter transmits a response to the at least one application after invoking the translated slice application programming interface.

In various embodiments, the first service parameter comprises a network parameter, a network function parameter, a managed function parameter, a managed entity attribute, a management service parameter, an application parameter, a slice parameter, a service parameter, a general network slice template parameter, an upper layer parameter related to the application or the network, or some combination thereof.

In one embodiment, the second service parameter comprises a network parameter, a network function parameter, a managed function parameter, a managed entity attribute, a management service parameter, an application parameter, a slice parameter, an entity provided parameter, a service parameter, a general network slice template parameter, an upper layer parameter related to the application or the network, or some combination thereof.

In certain embodiments, the first service parameter and the second service parameter are the same.

In some embodiments, the application comprises at least one application located at an edge platform, a regional cloud platform, distributed over different cloud platforms, or some combination thereof.

In various embodiments, the application comprises an application function, an application server, an application client, an application enabler server, an application enabler client, a vertical application specific server, a vertical application specific client, or a combination thereof.

In one embodiment, the slice application programming interface comprises at least one service application programming interface, at least a portion of one service application programming interface, or a combination thereof.

In certain embodiments, the receiver receives slice information before receiving the request for invoking the service application programming interface, and the slice information comprises application to slice subscriptions, slice profiles, service profiles, slice exposure requirements, slice to service mapping, or some combination thereof.

In some embodiments, the processor authorizes mapping the service application programing interface to the slice application programming interface before translating the service application programming interface to the slice application programming interface.

In various embodiments, the service application programming interface comprises a control application programming interface, a network exposure function application programming interface, a service capability exposure function application programming interface, a management application programming interface, a metro ethernet forum application programming interface, an exposure governance management function application programming interface, a management service application programming interface, a service enabler architecture layer application programming interface, an application function application programming interface, a mobile edge computing application programming interface, an open radio access network application programming interface, a radio access network intelligent controller application programming interface, or some combination thereof.

In one embodiment, the processor subscribes to providers of the service application programming interface for consuming the service application programming interface after the receiver receives the request for invoking the service application programming interface.

In certain embodiments, the apparatus comprises an entity having the form of: a network slice enabler, a middleware, a slice enabling service, a slice enabling function, a mobile edge computing platform function, an edge enabler server, an edge enabler client, an xApp, an rApp, an API management service, a radio access network intelligent controller function, or some combination thereof.

In some embodiments, the entity is executed on a cloud platform, an edge cloud platform as a platform capability function, or application.

In various embodiments, the processor invoking the translated slice application programming interface comprises the processor making a translated slice application programming interface request to a service producer, the receiver receiving a translated slice application programming interface response from the service producer, or a combination thereof.

In one embodiment, the processor translates the service application programming interface to the slice application programming interface by enabling a software development kit.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a user equipment (UE), the method comprising:
receiving a request for invoking a service application programming interface (API);
translating the service API to a slice API; and
invoking the translated slice API.

2. The method of claim 1, wherein:
receiving the request for invoking the service API comprises receiving a first service parameter from an application over the service API;
translating the service API to the slice API comprises determining a second service parameter based on the first service parameter and a level of slice capability exposure; and
invoking the translated slice API comprises transmitting the second service parameter to at least one service producer over the translated slice API.

3. The method of claim 1, further comprising transmitting a response to at least one application after invoking the translated slice API.

4. The method of claim 2, wherein the first service parameter comprises a network parameter, a network function parameter, a managed function parameter, a managed entity attribute, a management service parameter, an application parameter, a slice parameter, a service parameter, a general network slice template parameter, an upper layer parameter related to the application or the network, or some a combination thereof.

5. The method of claim 2, wherein the second service parameter comprises a network parameter, a network function parameter, a managed function parameter, a managed entity attribute, a management service parameter, an application parameter, a slice parameter, an entity provided parameter, a service parameter, a general network slice template parameter, an upper layer parameter related to the application or the network, or a combination thereof.

6. The method of claim 1, wherein the slice API comprises at least one service API, at least a portion of one service API, or a combination thereof.

7. The method of claim 1, further comprising receiving slice information before receiving the request for invoking the service API, wherein the slice information comprises application to slice subscriptions, slice profiles, service profiles, slice exposure requirements, slice to service mapping, or a combination thereof.

8. The method of claim 1, further comprising authorizing mapping the service application programing interface to the slice API before translating the service API to the slice API.

9. The method of claim 1, wherein the service API comprises a control API, a network exposure function API, a service capability exposure function API, a management API, a metro ethernet forum API, an exposure governance management function API, a management service API, a service enabler architecture layer API, an application function API, a mobile edge computing API, an open radio access network (RAN) API, a RAN intelligent controller API, or a combination thereof.

10. The method of claim 1, wherein the method is performed by an entity having a form of: a network slice enabler, a middleware, a slice enabling service, a slice enabling function, a mobile edge computing platform function, an edge enabler server, an edge enabler client, an xApp, an rApp, an API management service, a radio access network (RAN) intelligent controller function, or a combination thereof.

11. The method of claim 1, wherein invoking the translated slice API comprises making a translated slice API request to a service producer, receiving a translated slice API response from the service producer, or a combination thereof.

12. A user equipment (UE), comprising:
at least one memory; and
at least one processor coupled with the at least one memory and configured to cause the UE to:
receive a request for invoking a service application programming interface (API);
translate the service API to a slice API; and
invoke the translated slice API.

13. The UE of claim 12, wherein the at least one processor is configured to cause the UE to:
receive a first service parameter from an application over the service API;
determine a second service parameter based on the first service parameter and a level of slice capability exposure; and
transmit the second service parameter to at least one service producer over the translated slice API.

14. The UE of claim 12, wherein the at least one processor is configured to cause the UE to transmit a response to at least one application after invoking the translated slice API.

15. The UE of claim 13, wherein the first service parameter comprises a network parameter, a network function parameter, a managed function parameter, a managed entity attribute, a management service parameter, an application parameter, a slice parameter, a service parameter, a general network slice template parameter, an upper layer parameter related to the application or the network, or a combination thereof.

16. The UE of claim 13, wherein the second service parameter comprises a network parameter, a network function parameter, a managed function parameter, a managed entity attribute, a management service parameter, an application parameter, a slice parameter, an entity provided parameter, a service parameter, a general network slice template parameter, an upper layer parameter related to the application or the network, or a combination thereof.

17. The UE of claim 12, wherein the at least one processor is configured to cause the UE to receive slice information before receiving the request for invoking the service API, and the slice information comprises application to slice subscriptions, slice profiles, service profiles, slice exposure requirements, slice to service mapping, or a combination thereof.

18. The UE of claim 12, wherein the service API comprises a control API, a network exposure function API, a service capability exposure function API, a management API, a metro ethernet forum API, an exposure governance management function API, a management service API, a service enabler architecture layer API, an application function API, a mobile edge computing API, an open radio access network (RAN) API, a RAN intelligent controller API, or a combination thereof.

19. The UE of claim 12, wherein the at least one processor is configured to cause the UE to make a translated slice API request to a service producer, receive a translated slice API response from the service producer, or a combination thereof.

20. (canceled)

21. A processor for wireless communication, comprising:
at least one controller coupled with at least one memory and configured to cause the processor to:
receive a request for invoking a service application programming interface (API);
translate the service API to a slice API; and
invoke the translated slice API.
